(19) United States
(12) Patent Application Publication
(10) Pub. No.: US 2018/0266987 A1
(43) Pub. Date: Sep. 20, 2018

(54) ION SENSOR CHIP

(71) Applicant: TOSHIBA TEC KABUSHIKI KAISHA, Tokyo (JP)

(72) Inventors: Atsushi Kubota, Sunto Shizuoka (JP); Takashi Kado, Mishima Shizuoka (JP)

(21) Appl. No.: 15/908,914

(22) Filed: Mar. 1, 2018

(30) Foreign Application Priority Data
Mar. 14, 2017 (JP) 2017-049101

(51) Int. Cl. G01N 27/414

(52) U.S. Cl. CPC G01N 27/4145; G01N 2001/4038

(57) ABSTRACT

In accordance with an embodiment, an ion sensor chip, which is connected to an inspection apparatus provided with a connection section having a plurality of connection terminals, comprises an ion sensor configured to measure an activity of an ion of a category corresponding to a composition of an ion sensitive membrane, and an identification information supply section configured to supply identification information corresponding to an inspection object ion of the ion sensor to the inspection apparatus.

### CROSS-REFERENCE TO RELATED APPLICATION

This application is based upon and claims the benefit of priority from Japanese Patent Application No. P2017-049101, filed Mar. 14, 2017, the entire contents of which are incorporated herein by reference.

### FIELD

Embodiments described herein relate generally to an ion sensor chip.

### BACKGROUND

A sensor chip (hereinafter, referred to as an ion sensor chip) is loaded with an ion sensitive field effect transistor (ISFET) for measuring a concentration of a specific ion in an aqueous liquid. The ion sensitive field effect transistor (hereinafter, referred to as an ion sensor) generates an electrode potential corresponding to a concentration of a specific ion contained in a liquid such as tap water, river water, sewage, industrial waste water, blood, urine, saliva, cerebrospinal fluid or the like.

The ion sensor is an FET whose gate surface is covered with an ion sensitive membrane. In the ion sensor, if a current in a drain to a source is constant, a gate voltage becomes a surface (interface) potential between solution and the ion sensitive membrane. A value of the surface potential between the solution and the ion sensitive membrane is determined by an activity of the ion (referred to as an inspection object ion) corresponding to a composition of the ion sensitive membrane in the liquid. If the current in the drain to the source is constant, a value of the gate voltage of the ion sensor is proportional to the concentration of the inspection object ion in the liquid.

The ion sensor can measure concentration of organic ions such as hydrogen ion (H+) or ammonium ion (NH4−) by changing a category of the ion sensitive membrane. The ion sensor can measure concentration of inorganic ions such as lithium ion (Li+), sodium ion (Na+), potassium ion (K+), magnesium ion (Mg2+), calcium ion (Ca2+), chlorine ion (Cl−), hydrogen carbonate ions (HCO3−), or carbonate ion (CO32−).

The ion sensor chip as described above is connected to an inspection apparatus having a connection section to which the ion sensor chip is connectable. The inspection object ion of the ion sensor chip differs depending on the composition of the ion sensitive membrane of the ion sensor loaded on the ion sensor chip. Therefore, if an ion sensor chip with an ion different from the ion set in the inspection apparatus as the inspection object ion is connected to the connection section of the inspection apparatus, there is a problem that normal inspection cannot be performed.

### DESCRIPTION OF THE DRAWINGS

FIG. 1 is a diagram illustrating a configuration example of an inspection apparatus according to a first embodiment;

FIG. 2 is a diagram illustrating a configuration example of an ion sensor chip according to the first embodiment;

FIG. 3 is a diagram illustrating a configuration example of an identification circuit according to the first embodiment;

FIG. 4 is a diagram illustrating a configuration example of an identification circuit according to a second embodiment;

FIG. 5 is a diagram illustrating a configuration example of the identification circuit according to the second embodiment;

FIG. 6 is a diagram illustrating a configuration example of an ion sensor chip according to a third embodiment;

FIG. 7 is a diagram illustrating a configuration example of an ion sensor chip according to a fourth embodiment;

FIG. 8 is a diagram illustrating a configuration example of an ion sensor chip according to a fifth embodiment;

FIG. 9 is a diagram illustrating a configuration example of a history record circuit according to the fifth embodiment; and

FIG. 10 is a diagram illustrating a configuration example of the history record circuit according to the fifth embodiment.

### DETAILED DESCRIPTION

In accordance with an embodiment, an ion sensor chip, which is connected to an inspection apparatus provided with a connection section having a plurality of connection terminals, comprises an ion sensor configured to measure an activity of an ion of a category corresponding to a composition of an ion sensitive membrane, and an identification information supply section configured to supply identification information corresponding to an inspection object ion of the ion sensor to the inspection apparatus.

Hereinafter, an ion sensor chip and an inspection apparatus to which the ion sensor chip is connected according to an embodiment are described with reference to the accompanying drawings.

### First Embodiment

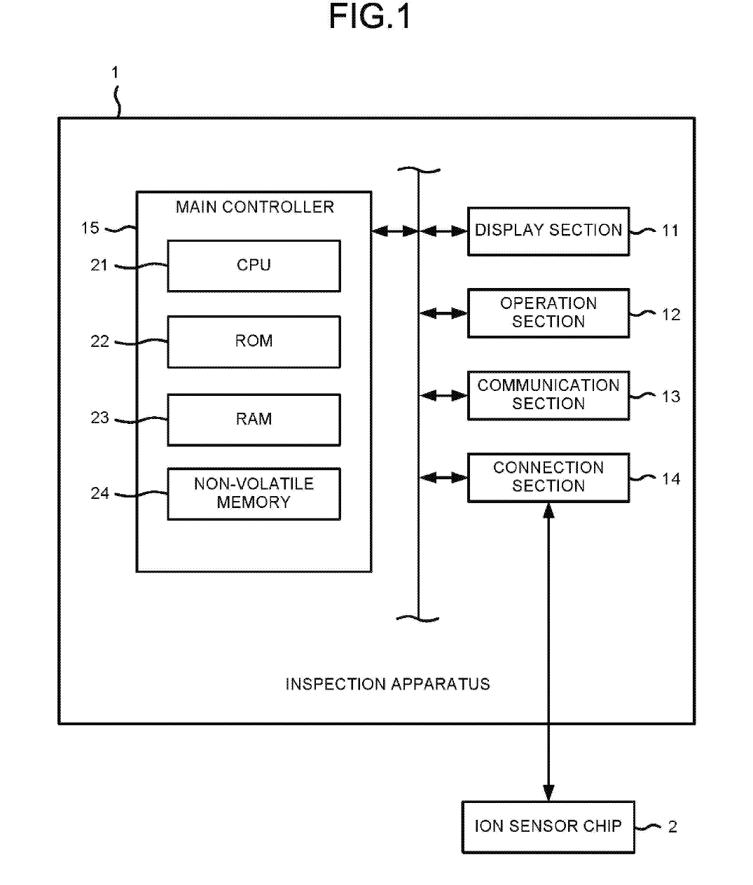

FIG. 1 is a diagram illustrating a configuration example of an inspection apparatus 1 according to the first embodiment.

The inspection apparatus 1 measures a concentration of a specific ion in aqueous liquid. The inspection apparatus measures a concentration of an inspection object ion according to a voltage of a terminal of an ion sensor chip 2 in a state in which the ion sensor chip 2 is connected.

The ion sensor chip 2 is loaded with at least one ion sensor. The ion sensor chip 2 generates a voltage corresponding to a concentration (more specifically, an activity) in liquid (inspection sample) of the ion (inspection object ion) of a category corresponding to a composition of an ion sensitive membrane constituting an ion sensor. The ion sensor chip 2 is operated as disposable material so as to prevent measurement accuracy from decreasing due to contamination (inspection sample remaining on the ion sensitive membrane) of the ion sensitive membrane. In the present embodiment, it is assumed that the ion sensor chip 2 is loaded with a plurality of the ion sensors each having the ion sensitive membrane having a different composition. The ion sensitive membrane is formed by applying liquid containing the composition of the ion sensitive membrane by a gravure printing method, an inkjet method or a non-contact method by a dispenser. The method of forming the ion sensitive membrane is not limited to this method, and may be any method.

(Configuration of Inspection Apparatus 1)

The inspection apparatus 1 comprises a display section 11, an operation section 12, a communication section 13, a connection section 14, and a main controller 15.

The display section 11 includes a display for displaying a screen in response to a video signal input from the main controller 15 or a display controller such as a graphic controller (not shown). For example, on the display of the display section 11, a screen for various settings of the inspection apparatus 1, a measurement result of the concentration of the inspection object ion, an alert, and the like are displayed.

The operation section 12 has an operation member (not shown). The operation section 12 generates an operation signal according to the operation of the operation member and supplies the operation signal to the main controller 15. The operation member is, for example, a touch sensor, a numeric keypad, a power key, various function keys, or a keyboard. The touch sensor is, for example, a resistance membrane type touch sensor, a capacitance type touch sensor, or the like. The touch sensor acquires information indicating a designated position within a certain area. The touch sensor and the display section 11 are integrally provided as a touch panel, and in this way, the touch sensor inputs an operation signal indicating the touched position on the screen displayed on the display section 11 to the main controller 15.

The communication section 13 is used for communicating with other devices. The communication section 13 is used, for example, to communicate with a host device uploading the measurement result measured by the inspection apparatus 1. The communication section 13 is, for example, a LAN connector. The communication section 13 may perform wireless communication with other devices by conforming to the standard such as Bluetooth (registered trademark) or Wi-fi (registered trademark).

The connection section 14 is an interface to which the ion sensor chip 2 is connected. The connection section 14 includes a plurality of terminals electrically connected to a plurality of signal lines of the ion sensor chip 2, a slot into which the ion sensor chip 2 is inserted, and a signal processing circuit which processes a signal input to the ion sensor chip 2 or a single output from the ion sensor chip 2. If the ion sensor chip 2 is inserted into the slot, the plurality of the signal lines of the ion sensor chip 2 and the plurality of terminals of the connection section 14 are electrically connected, respectively.

The connection section 14 inputs a signal to the ion sensor chip 2 by the signal processing circuit under the control of the main controller 15. Under the control of the main controller 15, the connection section 14 executes a signal processing on the signal output from the ion sensor chip 2 with the signal processing circuit, and supplies the signal subjected to the signal processing to the main controller 15.

The main controller 15 controls the inspection apparatus 1. The main controller 15 includes, for example, a CPU 21, a ROM 22, a RAM 23, and a non-volatile memory 24.

The CPU 21 is an arithmetic element (for example, a processor) that executes an arithmetic processing. The CPU executes various processing based on data such as a program stored in the ROM 22. By executing the program stored in the ROM 22, the CPU 21 functions as a controller capable of executing various operations.

The ROM 22 is a read-only non-volatile memory. The ROM 22 stores a program and data used in the program.

The RAM 23 is a volatile memory functioning as a working memory. The RAM 23 temporarily stores data being processing by the CPU 21. The RAM 23 temporarily stores a program executed by the CPU 21.

The non-volatile memory 24 is a storage medium capable of storing various information. The non-volatile memory 24 stores a program and data used in the program. The non-volatile memory 24 is, for example, a solid state drive (SSD), a hard disk drive (HDD), or other storage devices. Instead of the non-volatile memory 24, a memory interface such as a card slot into which a storage medium such as a memory card can be inserted may be provided.

(Configuration of the Ion Sensor Chip 2)

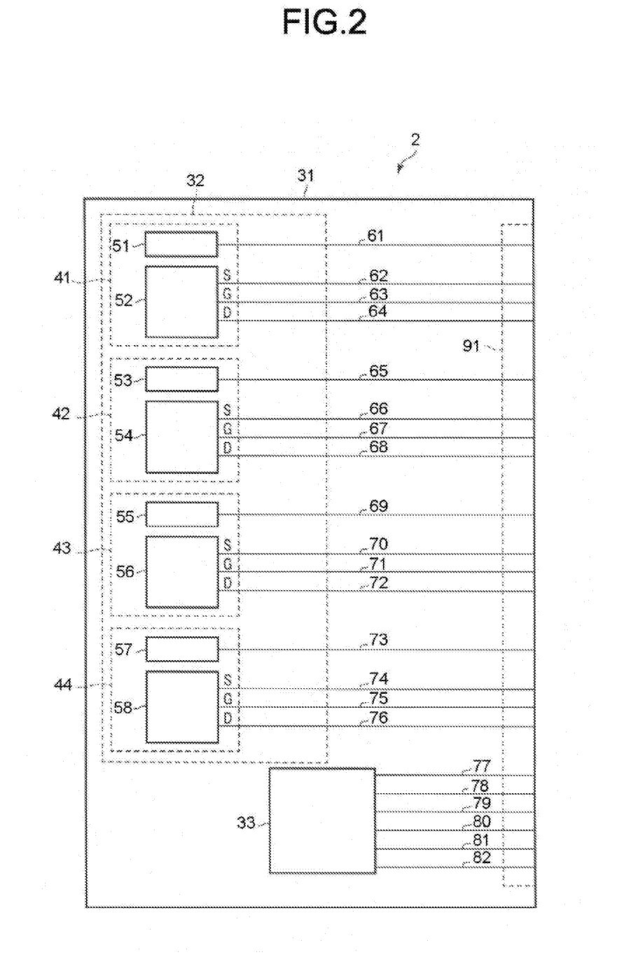

FIG. 2 is a diagram illustrating a configuration example of the ion sensor chip 2 according to the first embodiment. The ion sensor chip 2 includes a substrate 31, a sensor section 32, and an identification circuit 33.

The substrate 31 is loaded with the sensor section 32 and the identification circuit 33.

The sensor section 32 includes at least one ion measurement section. In the present embodiment, it is assumed that the sensor section 32 has a plurality of ion measurement sections. For example, in the example in FIG. 2, the sensor section 32 includes a first ion measurement section 41, a second ion measurement section 42, a third ion measurement section 43, and a fourth ion measurement section 44.

The first ion measurement section 41 includes a first reference electrode 51 and a first ion sensor 52. A signal line 61 is connected to the first reference electrode 51. The first ion sensor 52 is an FET whose gate surface is covered with the ion sensitive membrane. The ion sensitive membrane of the first ion sensor 52 is configured so as to set the ion of a first category as the inspection object ion. The first ion sensor 52 has a source terminal, a gate terminal, and a drain terminal. A signal line 62 is connected to the source terminal of the first ion sensor 52. A signal line 63 is connected to the gate terminal of the first ion sensor 52. A signal line 64 is connected to the drain terminal of the first ion sensor 52. The signal line 61 to the signal line 64 are connected to terminals of the connection section 14 if the ion sensor chip 2 is connected to the connection section 14 of the inspection apparatus 1.

If a constant current flows between the drain terminal and the source terminal of the first ion sensor 52 of the first ion measurement section 41 constituted as described above, the potential of the gate terminal of the first ion sensor 52 is a value corresponding to the activity of the inspection object ion (the ion of the first category) in the inspection sample in contact with the ion sensitive membrane.

The main controller 15 of the inspection apparatus 1 inputs and outputs a signal to and from the first ion measurement section 41 by controlling the connection section 14. As a result, the main controller 15 measures the activity of the inspection object ion corresponding to the composition of the ion sensitive membrane of the first ion sensor 52 with the first ion measurement section 41 constituted as described above. The main controller 15 of the inspection apparatus 1 measures the activity of the inspection object ion in the inspection sample in contact with the ion sensitive membrane of the first ion sensor 52 according to a potential difference between the signal line 61 and the signal line 63 when the current between the signal line 62 and the signal line 64 is controlled to be constant.

The second ion measurement section 42 includes a second reference electrode 53 and a second ion sensor 54. A signal line 65 is connected to the second reference electrode 53. The second ion sensor 54 is an FET whose gate surface is covered with the ion sensitive membrane. The ion sensitive membrane of the second ion sensor 54 is configured so as to set the ion of a second category as the inspection object ion. The second ion sensor 54 has a source terminal, a gate terminal, and a drain terminal. A signal line 66 is connected to the source terminal of the second ion sensor 54. A signal line 67 is connected to the gate terminal of the second ion sensor 54. A signal line 68 is connected to the drain terminal of the second ion sensor 54. The signal line 65 to the signal line 68 are connected to the terminals of the connection section 14 if the ion sensor chip 2 is connected to the connection section 14 of the inspection apparatus 1.

If a constant current flows between the drain terminal and the source terminal of the second ion sensor 54 of the second ion measurement section 42 constituted as described above, a potential of the gate terminal of the second ion sensor 54 is a value corresponding to the activity of the inspection object ion (ion of the second category) in the inspection sample in contact with the ion sensitive membrane.

The main controller 15 of the inspection apparatus 1 inputs and outputs a signal to and from the second ion measurement section 42 by controlling the connection section 14. As a result, the main controller 15 measures the activity of the inspection object ion corresponding to the composition of the ion sensitive membrane of the second ion sensor 54 with the second ion measurement section 42 constituted as described above. The main controller 15 of the inspection apparatus 1 measures the activity of the inspection object ion in the inspection sample in contact with the ion sensitive membrane of the second ion sensor 54 according to a potential difference between the signal line 65 and the signal line 67 when the current between the signal line 66 and the signal line 68 is controlled to be constant.

The third ion measurement section 43 includes a third reference electrode 55 and a third ion sensor 56. A signal line 69 is connected to the third reference electrode 55. The third ion sensor 56 is an FET whose gate surface is covered with the ion sensitive membrane. The ion sensitive membrane of the third ion sensor 56 is configured so as to set the ion of a third category as the inspection object ion. The third ion sensor 56 has a source terminal, a gate terminal, and a drain terminal. A signal line 70 is connected to the source terminal of the third ion sensor 56. A signal line 71 is connected to the gate terminal of third ion sensor 56. A signal line 72 is connected to the drain terminal of third ion sensor 56. The signal line 69 to the signal line 72 are connected to the terminals of the connection section 14 if the ion sensor chip 2 is connected to the connection section 14 of the inspection apparatus 1.

If a constant current flows between the drain terminal and the source terminal of the third ion sensor 56 of the third ion measurement section 43 constituted as described above, a potential of the gate terminal of the third ion sensor 56 is a value corresponding to the activity of the inspection object ion (ion of a third category) in the inspection sample in contact with the ion sensitive membrane.

The main controller 15 of the inspection apparatus 1 inputs and outputs a signal to and from the third ion measurement section 43 by controlling the connection section 14. As a result, the main controller 15 measures the activity of the inspection object ion corresponding to the composition of the ion sensitive membrane of the third ion sensor 56 with the third ion measurement section 43 constituted as described above. The main controller 15 of the inspection apparatus 1 measures the activity of the inspection object ion in the inspection sample in contact with the ion sensitive membrane of the third ion sensor 56 according to a potential difference between the signal line 69 and the signal line 71 when the current between the signal line 70 and the signal line 72 is controlled to be constant.

The fourth ion measurement section 44 includes a fourth reference electrode 57 and a fourth ion sensor 58. A signal line 73 is connected to the fourth reference electrode 57. The fourth ion sensor 58 is an FET whose gate surface is covered with the ion sensitive membrane. The ion sensitive membrane of the fourth ion sensor 58 is configured so as to set the ion of a fourth category as the inspection object ion. The fourth ion sensor 58 has a source terminal, a gate terminal, and a drain terminal. A signal line 74 is connected to the source terminal of the fourth ion sensor 58. A signal line 75 is connected to the gate terminal of the fourth ion sensor 58. A signal line 76 is connected to the drain terminal of the fourth ion sensor 58. The signal line 73 to the signal line 76 are connected to the terminals of the connection section 14 if the ion sensor chip 2 is connected to the connection section 14 of the inspection apparatus 1.

If a constant current flows between the drain terminal and the source terminal of the fourth ion sensor 58 of the fourth ion measurement section 44 constituted as described above, a potential of the gate terminal of the fourth ion sensor 58 is a value corresponding to the activity of the inspection object ion (ion of a fourth category) in the inspection sample in contact with the ion sensitive membrane.

The main controller 15 of the inspection apparatus 1 inputs and outputs a signal to and from the fourth ion measurement section 44 by controlling the connection section 14. As a result, the main controller 15 measures the activity of the inspection object ion corresponding to the composition of the ion sensitive membrane of the fourth ion sensor 58 with the fourth ion measurement section 44 constituted as described above. The main controller 15 of the inspection apparatus 1 measures the activity of the inspection object ion in the inspection sample in contact with the ion sensitive membrane of the fourth ion sensor 58 according to a potential difference between the signal line 73 and the signal line 75 when the current between the signal line 74 and the signal line 76 is controlled to be constant.

The identification circuit 33 supplies identification information for identifying the ion sensor chip 2 to the inspection apparatus 1. More specifically, the identification circuit 33 supplies the categories of the ions measurable by the sensor section 32, i.e., identification information corresponding to a combination of the inspection object ions to the inspection apparatus 1. The identification circuit 33 functions as an identification information supply section which supplies the identification information corresponding to the category (inspection object ion) of the ion detected by the ion sensor to the inspection apparatus 1.

For example, in the example in FIG. 2, a signal line for identification 77, a signal line for identification 78, a signal line for identification 79, a signal line for identification 80, a L-level signal line 81, and a H-level signal line 82 are connected to the identification circuit 33. The signal line for identification 77, the signal line for identification 78, the signal line for identification 79, the signal line for identification 80, the L-level signal line 81, and the H-level signal line 82 are connected to the terminals of the connection section 14 if the ion sensor chip 2 is connected to the connection section 14 of the inspection apparatus 1.

The signal line for identification 77 to the signal line for identification 80 are used for supplying the identification information indicating the combination of the inspection object ions in the ion sensor chip 2 to the inspection apparatus 1.

If the ion sensor chip 2 is connected to the connection section 14 of the inspection apparatus 1, a potential of the L-level signal line 81 is lowered to a low level (L level) by the inspection apparatus 1. The L level is, for example, GND.

If the ion sensor chip 2 is connected to the connection section 14 of the inspection apparatus 1, a potential of the H-level signal line 82 is raised to a high level (H level) by the inspection apparatus 1.

The signal line 61 to the signal line 76, the signal line for identification 77 to the signal line for identification 80, the L-level signal line 81, and the H-level signal line 82 are respectively formed by conductive metal and the like as connection terminals on the surface of the substrate 31. These signal lines are arranged at a position in contact with the plurality of terminals of the connection section 14 if the ion sensor chip 2 is connected to the connection section 14 of the inspection apparatus 1. These signal lines are electrically connected to the connection section 14 of the inspection apparatus 1 by contacting with the plurality of terminals of the connection section 14 of the inspection apparatus 1, respectively. These signal lines extend to a certain side of the substrate 31, for example, as shown in FIG. 2. The side of the substrate 31 to which a plurality of the signal lines extends is constituted as an insertion section 91 inserted into the slot of the connection section 14 of the inspection apparatus 1.

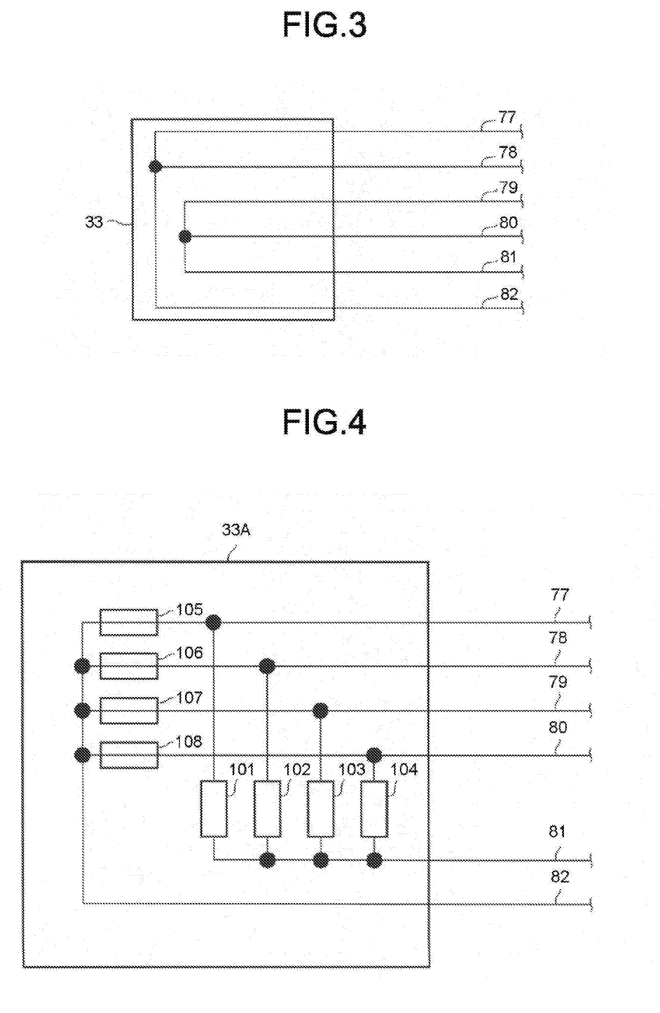

FIG. 3 is a diagram illustrating a configuration example of the identification circuit 33. In the identification circuit 33, the signal line for identification 77, the signal line for identification 78, the signal line for identification 79, and the signal line for identification 80 are connected to the L-level signal line 81 or the H-level signal line 82, respectively. A plurality of the signal lines for identification is connected to the L-level signal line and the H-level signal line 82 according to the combination of the inspection object ions of the ion sensor chip 2. The connection relationship in the identification circuit 33 between the signal line for identification 77 to the signal line for identification 80 and the L-level signal line 81 and the H-level signal line 82 is determined according to the combination of the inspection object ions of the ion sensor chip 2.

The main controller 15 of the inspection apparatus 1 controls the connection section 14 to input and output a signal to and from the identification circuit 33. For example, if the ion sensor chip 2 constituted as described above is connected to the connection section 14 of the inspection apparatus 1, the main controller 15 lowers the L-level signal line 81 to the L level and raises the H-level signal line 82 to the H level. In this case, the voltages of the signal line for identification 77 to the signal line for identification 80 connected to the identification circuit 33 are determined depending on whether the signal line for identification 77 to the signal line for identification 80 are connected to the L-level signal line 81 or the H-level signal line 82. By detecting the voltages of the signal line for identification 77 to the signal line for identification 80 connected to the identification circuit 33, the main controller 15 can recognize the connection relationship in the identification circuit 33 between the signal line for identification 77 to the signal line for identification 80 and the L-level signal line 81 and the H-level signal line 82. The main controller 15 identifies the combination of the inspection object ions of the ion sensor chip 2 according to the recognized connection relationship. The main controller 15 recognizes the categories of the ions that can be measured by the connected ion sensor chip 2 based on the voltages of the signal line for identification 77 to the signal line for identification 80 at the time of lowering the L-level signal line 81 to the L level and raising the H-level signal line 82 to the H level.

The main controller 15 detects the voltages of the signal line for identification 77 to the signal line for identification 80 as, for example, binary logical values. The main controller 15 previously stores an identification table indicating a combination of the inspection object ions in the non-volatile memory 24 for each combination of logical values of the signal line for identification 77 to the signal line for identification 80. By referring to the identification table, the main controller 15 recognizes the combination of the inspection object ions corresponding to the logical values of the signal line for identification 77 to the signal line for identification 80. As a result, the main controller 15 recognizes the combination of the inspection object ions that can be measured by the connected ion sensor chip 2.

For example, as shown in FIG. 2, the ion sensor chip 2 is loaded with the first ion sensor 52 capable of measuring the ion of the first category, the second ion sensor 54 capable of measuring the ion of the second category, the third ion sensor 56 capable of measuring the ion of the third category and the fourth ion sensor 58 capable of measuring the ion of the fourth category. As shown in FIG. 3, in the identification circuit 33, the signal line for identification 77 and the signal line for identification 78 are connected to the H-level signal line 82, and the signal line for identification 79 and the signal line for identification 80 are connected to the L-level signal line 81.

The main controller 15 of the inspection apparatus 1 lowers the L-level signal line 81 to the L level and raises the H-level signal line 82 to the H level. In this case, the signal line for identification 77 and the signal line for identification 78 connected to the H-level signal line 82 are at the H level (logical value “1”), and the signal line for identification 79 and the signal line for identification 80 connected to the L-level signal line 81 are at the L level (logical value “0”). If the logical value of the signal line for identification 77 is “1”, the logical value of the signal line for identification 78 is “1”, the logical value of the signal line for identification 79 is “0”, and the logical value of the signal line for identification 80 is “0”, the main controller 15 of the inspection apparatus 1 recognizes that the inspection object ions of the ion sensor chip 2 are those of the first category, the second category, the third category, and the fourth category.

The main controller 15 of the inspection apparatus 1 compares the identification information acquired from the ion sensor chip 2 connected to the connection section 14 with the identification information previously stored (set) in the non-volatile memory 24. If they are coincident with each other, the main controller 15 determines that the correct ion sensor chip 2 is connected to the connection section 14. Otherwise, if they are not coincident with each other, the main controller 15 determines an erroneous ion sensor chip 2 is connected to the connection section 14. If it is determined that the erroneous ion sensor chip 2 is connected to the connection section 14, the main controller 15 may output an alert on the display section 11. As a result, if an ion sensor chip different from the ion sensor chip 2 preset as a device for inspection, i.e., an erroneous ion sensor chip is connected to the connection section 14, the inspection apparatus 1 can notify a user thereof that the ion sensor chip connected to the connection section 14 is erroneous.

As described above, the ion sensor chip 2, which is connected to the inspection apparatus 1 provided with the connection section 14 having a plurality of the connection terminals, comprises an ion sensor for measuring the activity of the ion of the category corresponding to the composition of the ion sensitive membrane, and an identification information supply section which supplies the identification information corresponding to the category of the ion (inspection object ion) detected by the ion sensor to the inspection apparatus 1. The ion sensor chip 2 supplies the identification information for identifying the category of the ion detected by the ion sensor to the inspection apparatus 1 with the identification information supply section. As a result, the inspection apparatus 1 can determine whether or not the ion sensor chip 2 connected to the connection section 14 is correct by determining whether or not the identification information supplied from the ion sensor chip 2 connected to the connection section 14 is coincident with the preset identification information. Furthermore, the inspection apparatus 1 can notify the user of the inspection apparatus 1 that the ion sensor chip 2 connected to the connection section 14 is erroneous if the ion sensor chip 2 connected to the connection section 14 is erroneous. As a result, the ion sensor chip 2 can prevent erroneous connection to the inspection apparatus 1.

The main controller 15 of the inspection apparatus 1 may refer to the identification table in response to the identification information acquired from the ion sensor chip connected to the connection section 14, recognize the inspection object ion of the ion sensor chip 2 connected to the connection section 14, and display information indicating the recognized inspection object ion on the display section 11. In this way, the inspection object ion of the ion sensor chip 2 connected to the connection section 14 can be notified to the user of the inspection apparatus 1.

The main controller 15 of the inspection apparatus 1 may not output an alert when the identification information different from the preset identification information is acquired from the ion sensor chip 2, but may output an alert when the identification information of the ion sensor chip 2 connected next is different.

The main controller 15 of the inspection apparatus 1 may output an alert as a sound through a speaker (not shown) instead of outputting an alert on the display section 11, or may output an alert as light by an indicator (not shown).

In the above embodiment, a configuration in which four signal lines for identification, i.e., the signal line for identification 77 to the signal line for identification 80 are connected to the identification circuit 33 is described; however, the present invention is not limited thereto. For example, more or fewer signal lines for identification may be connected to the identification circuit 33.

In the above embodiment, a configuration of the ion sensor chip 2 in which a reference electrode is provided for each ion measurement section is described; however, the present invention is not limited thereto. For example, one reference electrode common to a plurality of ion measurement sections may be provided in the ion sensor chip 2.

### Second Embodiment

The second embodiment differs from the first embodiment in the configuration of the identification circuit 33. The identification circuit in the second embodiment is referred to as an identification circuit 33A and is described below.

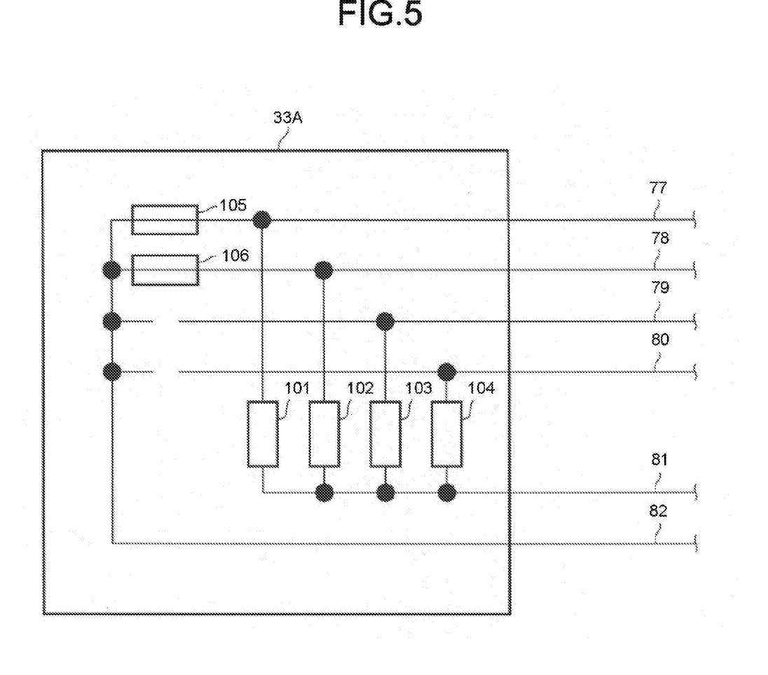

The identification circuit 33A of the ion sensor chip 2 supplies the identification information for identifying the ion sensor chip 2 to the inspection apparatus 1. In the example in FIG. 4, the signal line for identification 77, the signal line for identification 78, the signal line for identification 79, the signal line for identification 80, the L-level signal line 81, and the H-level signal line 82 are connected to the identification circuit 33A.

As shown in FIG. 4, the identification circuit 33A includes a first resistance 101, a second resistance 102, a third resistance 103, a fourth resistance 104, a first fuse 105, a second fuse 106, a third fuse 107, and a fourth fuse 108. The fuse is, for example, a current fusible type chip fuse that can be mounted on the surface of the substrate 31.

The first resistance 101 is connected between the signal line for identification 77 and the L-level signal line 81.

The second resistance 102 is connected between the signal line for identification 78 and the L-level signal line 81.

The third resistance 103 is connected between the signal line for identification 79 and the L-level signal line 81.

The fourth resistance 104 is connected between the signal line for identification 80 and the L-level signal line 81.

The first fuse 105 is connected between a connection point between the signal line for identification 77 and the L-level signal line 81 and the H-level signal line 82.

The second fuse 106 is connected between a connection point between the signal line for identification 78 and the L-level signal line 81 and the H-level signal line 82.

The third fuse 107 is connected between a connection point between the signal line for identification 79 and the L-level signal line 81 and the H-level signal line 82.

The fourth fuse 108 is connected between a connection point between the signal line for identification 80 and the L-level signal line 81 and the H-level signal line 82.

The first fuse 105 to the fourth fuse 108 of the identification circuit 33A are blown according to the combination of the inspection object ions of the ion sensor chip 2 at the time of manufacture. For example, as shown in FIG. 5, in a state in which the third fuse 107 and the fourth fuse 108 are blown, the L-level signal line 81 is lowered to the L level and the H-level signal line 82 is raised to the H level. In this case, since the signal line for identification 77 and the signal line for identification 78 are connected to the H-level signal line 82 via the first fuse 105 and the second fuse 106, the logical values thereof become “1”. Since the third fuse 107 and the fourth fuse 108 are blown and the signal line for identification 79 and the signal line for identification 80 are connected to the L-level signal line 81 via the third resistance 103 and the fourth resistance 104, the logical values thereof become “0”.

According to such a configuration, by fusing the first fuse 105 to the fourth fuse 108 of the identification circuit 33A according to the combination of the inspection object ions of the ion sensor chip 2 at the time of manufacture, the connection relationship between the signal line for identification 77 to the signal line for identification 80 and the L-level signal line 81 and the H-level signal line 82 can be changed. By such a configuration, the ion sensor chip 2 can also supply the identification information indicating the category of the ion detected by the ion sensor to the inspection apparatus 1. As a result, it is possible to prevent the ion sensor chip 2 from being erroneously connected to the inspection apparatus 1.

### Third Embodiment

The third embodiment is different from the first embodiment in the connection of the signal lines on the substrate 31 of the ion sensor chip 2. The ion sensor chip in the third embodiment is referred to as an ion sensor chip 2B and is described below.

The ion sensor chip 2B comprises the substrate 31, a sensor section 32B, and the identification circuit 33.

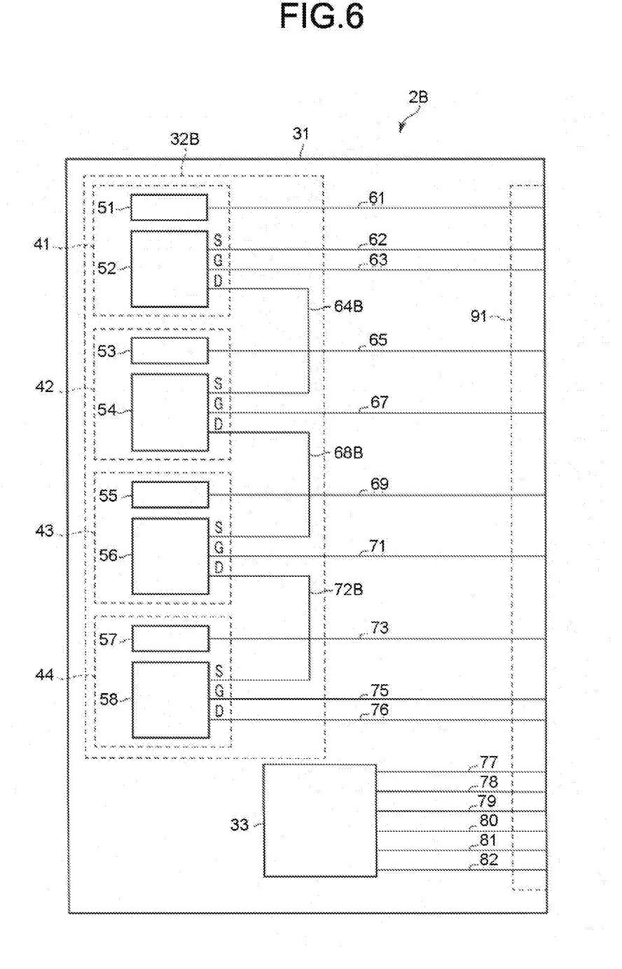

The sensor section 32B includes a plurality of ion measurement sections. In the present embodiment, the sensor section 32B has a plurality of the ion measurement sections. For example, in the example in FIG. 6, the sensor section 32B includes the first ion measurement section 41, the second ion measurement section 42, the third ion measurement section 43, and the fourth ion measurement section 44.

In the first ion sensor 52 of the first ion measurement section 41, the signal line 62 is connected to the source terminal, the signal line 63 is connected to the gate terminal, and a signal line 64B is connected to the drain terminal.

In the second ion sensor 54 of the second ion measurement section 42, the signal line 64B is connected to the source terminal, the signal line 67 is connected to the gate terminal, and a signal line 68B is connected to the drain terminal.

In the third ion sensor 56 of the third ion measurement section 43, the signal line 68B is connected to the source terminal, the signal line 71 is connected to the gate terminal, and a signal line 72B is connected to the drain terminal.

In the fourth ion sensor 58 of the fourth ion measurement section 44, the signal line 72B is connected to the source terminal, the signal line 75 is connected to the gate terminal, and the signal line 76 is connected to the drain terminal.

The signal lines 61, 62, 63, 64B, 65, 67, 68B, 69, 71, 72B, 73, 75, and 76, the signal line for identification 77 to the signal line for identification 80, the L-level signal line 81, and the H-level signal line 82 are respectively formed by conductive metal as the connection terminals on the surface of the substrate 31. These signal lines are arranged at a position in contact with the plurality of terminals of the connection section 14 when the ion sensor chip 2B is connected to the connection section 14 of the inspection apparatus 1. These signal lines are electrically connected to the connection section 14 of the inspection apparatus 1 by respectively contacting with the plurality of terminals of the connection section 14 of the inspection apparatus 1. These signal lines extend to a certain side of the substrate 31 as shown in FIG. 6, for example. The side of the substrate 31 to which the plurality of the signal lines extends is constituted as an insertion section 91 inserted into the slot of the connection section 14 of the inspection apparatus 1.

According to the above configuration, the connection section 14 of the inspection apparatus 1 controls so that a constant current flows in the signal line 62 to the signal line 76, and in this way, a constant current flows in the source terminal to the drain terminal of the first ion sensor 52, the source terminal to the drain terminal of the second ion sensor 54, the source terminal to the drain terminal of the third ion sensor 56, the source terminal to the drain terminal of the fourth ion sensor 58. With such a configuration, the ion sensor chip 2B can also supply a voltage corresponding to the activity of the inspection object ion to the inspection apparatus 1.

### Fourth Embodiment

The fourth embodiment differs from the first embodiment in that it supplies the identification information to the inspection apparatus 1 by using RFID. The ion sensor chip in the fourth embodiment is referred to as an ion sensor chip 2C, and the connection section of the inspection apparatus is referred to as a connection section 14C, and the description thereof is made below.

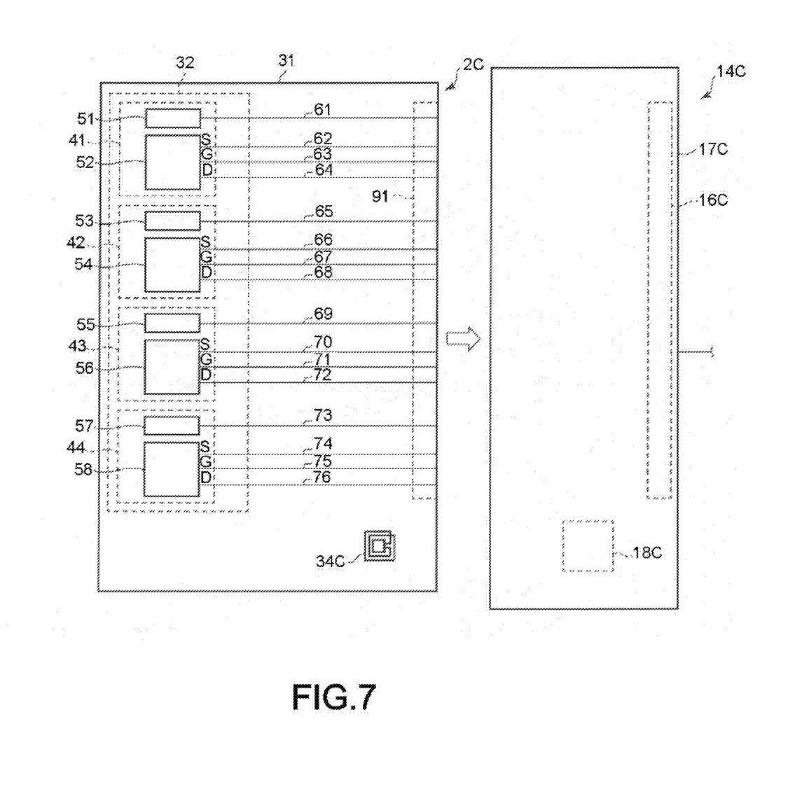

FIG. 7 is a diagram illustrating a configuration example of the ion sensor chip 2C and the connection section 14C according to the fourth embodiment.

The ion sensor chip 2C includes the substrate 31, the sensor section 32, and an IC tag 34C.

The IC tag 34C includes an IC chip and a circuit for communication. The IC chip includes a CPU, a ROM, a RAM, and a non-volatile memory. The non-volatile memory of the IC chip stores the identification information according to the combination of the inspection object ions of the ion sensor chip 2C. The circuit for communication is constituted as, for example, an antenna.

The IC tag 34C is, for example, a UHF passive tag. According to standard of the EPC Class 1 Generation 2, the UHF passive tag has four banks such as “EPC bank”, “TID bank”, “User bank”, and “Reserved bank” in the memory. For example, the IC tag 34C stores identification information corresponding to the combination of the inspection object ions of the ion sensor chip 2C in the “User bank”. More specifically, the IC tag 34C stores identification information indicating the combination of the inspection object ions of the ion sensor chip 2C by using 4 bits of the “User bank” which is constituted by 32 bits. The IC tag 34C may further store information such as manufacture lot of the ion sensor chip 2C in the “User bank”. The IC tag 34C is created at the time of manufacture of the ion sensor chip 2C. The IC tag 34C is attached to the ion sensor chip 2C, for example, by being directly printed on the substrate 31 by an inkjet method, or by attaching a label (IC tag label) to which the IC tag is attached to the substrate 31.

The connection section 14C is an interface to which the ion sensor chip 2C is connected. The connection section 14C includes a plurality of terminals 16C electrically connected to a plurality of the signal lines of the ion sensor chip 2C, a slot 17C into which the ion sensor chip 2C is inserted, an IC tag reader/writer 18C that communicates with the IC tag 34C of the ion sensor chip 2C, and a signal processing circuit (not shown) that processes a signal to be input to the ion sensor chip 2C or a signal output from the ion sensor chip 2C.

If the ion sensor chip 2C is inserted into the slot 17C, a plurality of the signal lines of the ion sensor chip 2C and a plurality of terminals 16C of the connection section 14C are electrically connected, respectively.

The connection section 14C inputs a signal to the ion sensor chip 2C by the signal processing circuit under the control of the main controller 15. Under the control of the main controller 15, the connection section 14C executes a signal processing with the signal processing circuit on the signal output from the ion sensor chip 2C, and then supplies the signal subjected to the signal processing to the main controller 15. As a result, the inspection apparatus 1 detects a voltage corresponding to the activity of the inspection object ion from the ion sensor chip 2C.

Further, the IC tag reader/writer 18C is provided at a position capable of communicating with the IC tag 34C of the ion sensor chip 2C inserted in the slot 17C. If the ion sensor chip 2C is inserted into the slot 17C, the communication between the IC tag 34C of the ion sensor chip 2C and the IC tag reader/writer 18C is enabled.

The main controller 15 of the inspection apparatus 1 transmits a command to the IC tag 34C of the ion sensor chip 2C by controlling the IC tag reader/writer 18C. The main controller 15 receives a response transmitted from the IC tag 34C of the ion sensor chip 2C by controlling the IC tag reader/writer 18C. The main controller 15 acquires information from the IC tag 34C by sending and receiving a command and a response to and from the IC tag 34C of the ion sensor chip 2C via the IC tag reader/writer 18C. For example, the main controller 15 acquires the identification information corresponding to the combination of the inspection object ions of the ion sensor chip 2C from the IC tag 34C by sending a specific command to the IC tag 34C.

With the above configuration, the ion sensor chip 2C can also supply the identification information indicating the category of the ion detected by the ion sensor to the inspection apparatus 1.

Furthermore, the main controller 15 may write the information in the IC tag 34C by sending and receiving the command and the response to and from the IC tag 34C of the ion sensor chip 2C via the IC tag reader/writer 18C. For example, if the measurement of the activity of the inspection object ion in the inspection sample is completed by using the ion sensor chip 2C, the main controller 15 may write information (history information) indicating whether or not the ion sensor chip 2C is already used by sending a specific command to the IC tag 34C. The main controller 15 reads the history information of the IC tag 34C of the ion sensor chip 2C by sending a specific command to the IC tag 34C. The IC tag 34C of the ion sensor chip 2C functions as a history information supply section that supplies the history information indicating whether or not the ion sensor chip 2C is already used to the inspection apparatus 1.

According to such a configuration, the ion sensor chip 2C can supply the history information indicating whether or not it is already used to the inspection apparatus 1. The main controller 15 of the inspection apparatus 1 can recognize whether or not the ion sensor chip 2C connected to the connection section 14C is already used by acquiring the history information from the ion sensor chip 2C. As a result, it is possible to prevent the sensor chip 2C already used from being connected to the inspection apparatus 1 to be used again.

The IC tag 34C may further store an offset value of the ion sensor loaded on the ion sensor chip 2C. The offset value is generated according to characteristics of the ion sensor caused by variation in the manufacture of the ion sensor. The offset value is generated according to the measured value at the time of inspection of the ion sensor after the manufacture and stored in the IC tag 34C. The IC tag 34C supplies the offset value to the inspection apparatus 1 when the ion sensor chip 2C is connected to the connection section 14C. The IC tag 34C functions as an offset value supply section that supplies an offset value corresponding to the characteristics of the ion sensor of the ion sensor chip 2C to the inspection apparatus 1.

Based on the offset value supplied from the IC tag 34C of the ion sensor chip 2C, the main controller 15 of the inspection apparatus 1 corrects the measurement result of the activity in the inspection sample of the inspection object ion by the ion sensor chip 2C.

According to such a configuration, the ion sensor chip 2C can supply the inspection apparatus 1 with the offset value used for correcting the measurement result. As a result, the accuracy of the measurement result in the inspection apparatus 1 can be improved.

### Fifth Embodiment

The fifth embodiment differs from the first embodiment in that the identification information is supplied to the inspection apparatus 1 by using image information such as a barcode or a two-dimensional code. The ion sensor chip in the fifth embodiment is referred to as an ion sensor chip 2D and the connection section in the inspection apparatus 1 is referred to as a connection section 14D, and the description thereof is described below.

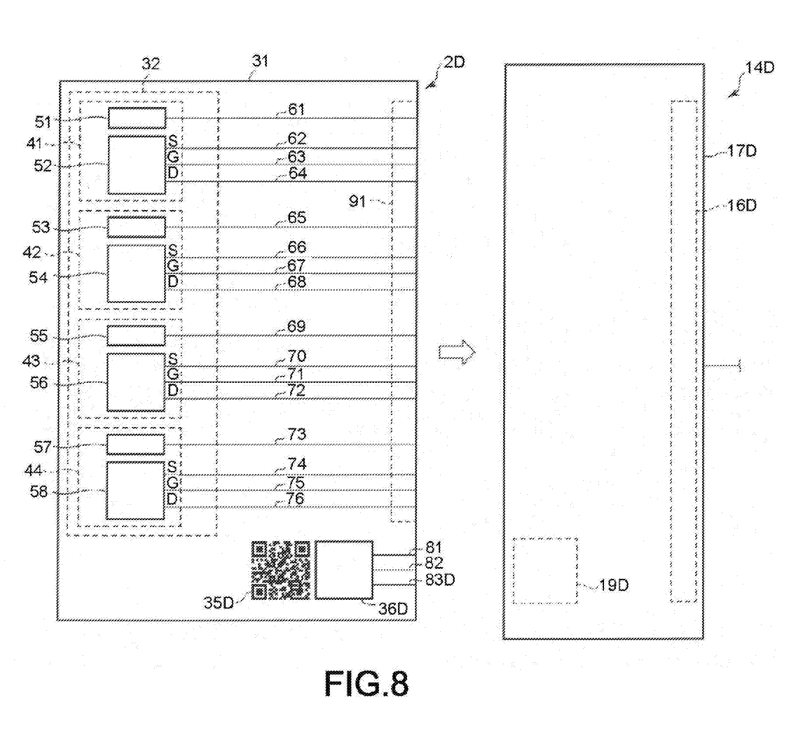

FIG. 8 is a diagram illustrating a configuration example of the ion sensor chip 2D and the connection section 14D according to the fifth embodiment.

The ion sensor chip 2D includes the substrate 31, the sensor section 32, a two-dimensional code 35D, and a history record circuit 36D.

The two-dimensional code 35D is image information generated based on the identification information indicating a combination of the inspection object ions of the ion sensor chip 2D. The two-dimensional code 35D includes the identification information indicating the combination of the inspection object ions of the ion sensor chip 2C. Further, the two-dimensional code 35D may include information indicating a manufacture lot of the ion sensor chip 2D. The two-dimensional code 35D may further include an offset value of the ion sensor loaded on the ion sensor chip 2C.

The two-dimensional code 35D may be formed by being directly printed on the substrate 31 by screen printing, an inkjet method, or the like, or may be formed by attaching a label printed with the two-dimensional code 35D to the substrate 31.

The connection section 14D is an interface to which the ion sensor chip 2D is connected. The connection section 14D includes a plurality of terminals 16D electrically connected to a plurality of the signal lines of the ion sensor chip 2D, a slot 17D into which the ion sensor chip 2D is inserted, a camera 19D that reads the two-dimensional code 35D of the ion sensor chip 2D, and a signal processing circuit (not shown) that processes a signal to be input to the ion sensor chip 2D or a signal output from the ion sensor chip 2D.

If the ion sensor chip 2D is inserted into the slot 17D, a plurality of the signal lines of the ion sensor chip 2D and a plurality of terminals 16D of the connection section 14D are electrically connected, respectively.

The connection section 14D inputs a signal to the ion sensor chip 2D with the signal processing circuit under the control of the main controller 15. Under the control of the main controller 15, the connection section 14D executes a signal processing on the signal output from the ion sensor chip 2D with the signal processing circuit, and then transmits the signal subjected to the signal processing to the main controller 15. As a result, the inspection apparatus 1 detects a voltage corresponding to the activity of the inspection object ion from the ion sensor chip 2D.

The camera 19D reads the two-dimensional code 35D of the ion sensor chip 2D inserted into the slot 17D. The camera 19D includes an image sensor, an optical element, and the like.

The image sensor is an image capturing element in which pixels for converting light to an electrical signal (image signal) are arranged linearly. The image sensor is constituted by, for example, a CCD, a CMOS, or another image capturing element.

The optical element images light from a predetermined reading range on the pixels of the image sensor. The reading range of the optical element is a range in which the two-dimensional code 35D of the ion sensor chip 2D can be read when the ion sensor chip 2D is inserted into the slot 17D.

When the ion sensor chip 2D is inserted into the slot 17D, the camera 19D can read the two-dimensional code 35D of the ion sensor chip 2D.

The main controller 15 of the inspection apparatus 1 acquires an image including the two-dimensional code 35D with the camera 19D from the ion sensor chip 2D inserted into the slot 17D. The main controller 15 acquires various information included in the two-dimensional code 35D by analyzing the acquired image. For example, the main controller 15 analyzes the image of the two-dimensional code 35D to acquire the identification information of the ion sensor chip 2D, and in this way, the main controller 15 recognizes the inspection object ion of the ion sensor chip 2D.

With the above configuration, the ion sensor chip 2D can also supply the identification information indicating the category of the ion detected by the ion sensor to the inspection apparatus 1. As a result, it is possible to prevent the ion sensor chip 2D from being erroneously connected to the inspection apparatus 1.

The history record circuit 36D supplies the inspection apparatus 1 with information (history information) indicating whether or not the ion sensor chip 2D is already used. The L-level signal line 81, the H-level signal line 82, and a signal line for history determination 83D are connected to the history record circuit 36D.

The signal line for history determination 83D is formed by a conductive metal as a connection terminal on the surface of the substrate 31. The signal line for history determination 83D is arranged at a position in contact with a plurality of terminals 16D of the connection section 14D if the ion sensor chip 2D is connected to the connection section 14D of the inspection apparatus 1. The signal line for history determination 83D is electrically connected to the connection section 14D of the inspection apparatus 1 by contacting with the plurality of terminals 16D of the connection section 14D. As shown in FIG. 8, the signal line for history determination 83D is formed so as to extend to a side constituting the insertion section 91 of the substrate 31.

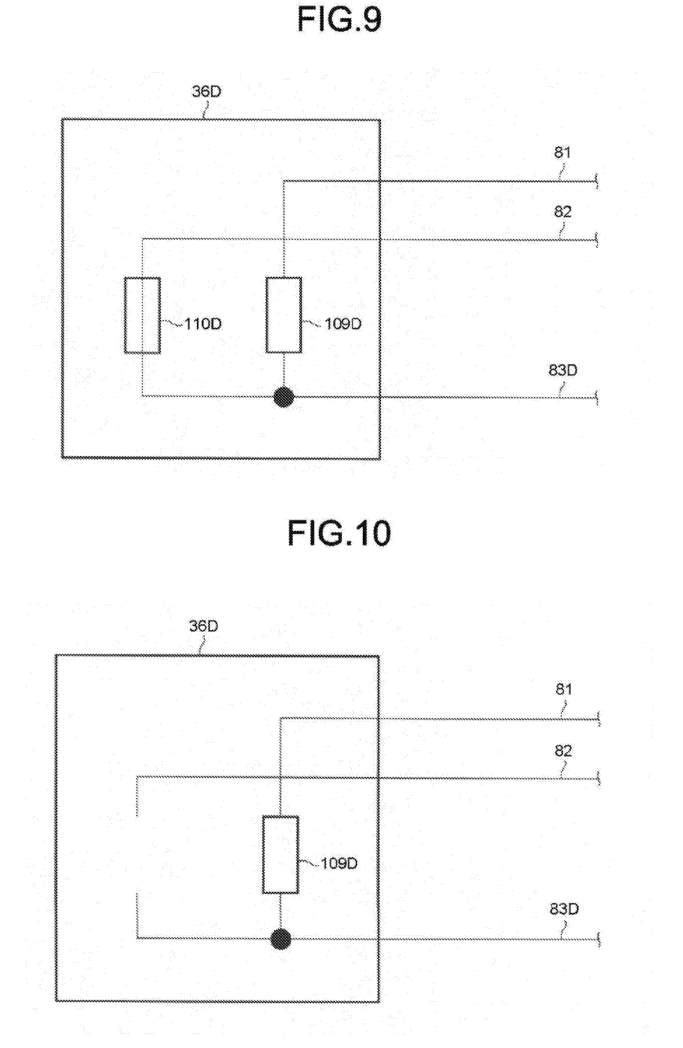

As shown in FIG. 9, the history record circuit 36D includes a resistance 109D and a fuse 110D. The fuse is, for example, a current fusible type chip fuse that can be mounted on the surface of the substrate 31.

The resistance 109D is connected between the signal line for history determination 83D and the L-level signal line 81.

The fuse 110D is connected between the signal line for history determination 83D and the H-level signal line 82.

For example, as shown in FIG. 9, in a state in which the fuse 110D is not blown, the L-level signal line 81 is lowered to the L level and the H-level signal line 82 is raised to the H level. In this case, since the signal line for history determination 83D of the history record circuit 36D is connected to the H-level signal line 82 via the fuse 110D, the logical value of the signal line for history determination 83D becomes “1”.

As shown in FIG. 10, for example, if the fuse 110D is blown, the L-level signal line 81 is lowered to the L level and the H-level signal line 82 is raised to the H level. In this case, since the signal line for history determination 83D of the history record circuit 36D is connected to the L-level signal line 81 via the resistance 109D, the logical value of the signal line for history determination 83D becomes “0”.

According to such a configuration, by fusing the fuse 110D, the logical value of the signal line for history determination 83D can be switched to “0” from “1”.

For example, if the measurement of the activity of the inspection object ion in the inspection sample by the ion sensor chip 2D is completed, the main controller 15 of the inspection apparatus 1 enables the current to flow to the signal line for history determination 83D to blow the fuse 110D. As a result, the main controller 15 can change the logical value of the signal line for history determination 83D from “0” indicating that the ion sensor chip 2D is not used to “1” indicating the ion sensor chip 2D has been already used. If the ion sensor chip 2D is connected to the connection section 14D, the main controller 15 determines whether the ion sensor chip 2D is not used or has been already used according to the logical value of the signal line for history determination 83D. The history record circuit 36D functions as a history information supply section that supplies the history information indicating whether or not the ion sensor chip 2D is already used to the inspection apparatus 1.

According to such a configuration, the ion sensor chip 2D can supply the information indicating whether or not it is used to the inspection apparatus 1. The main controller 15 of the inspection apparatus 1 can recognize whether or not the ion sensor chip 2D is already used according to the logical value of the signal line for history determination 83D of the history record circuit 36D. As a result, it is possible to prevent the sensor chip 2D already used from being connected to the inspection apparatus 1 to be used again.

The functions described in the above embodiments can be realized not only by using hardware but also by reading a program recording each function in a computer by using software. Each function may be configured by selecting software or hardware as appropriate.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An ion sensor chip, which is connected to an inspection apparatus provided with a connection section having a plurality of connection terminals, comprising:
an ion sensor configured to measure an activity of an ion of a category corresponding to a composition of an ion sensitive membrane covering the ion sensor; and
an identification information supply section configured to supply identification information corresponding to an inspection object ion of the ion sensor to the inspection apparatus.

2. The ion sensor chip according to claim 1, further comprising:
a plurality of ion sensors each having a different inspection object ion, wherein
the identification information indicates a combination of the inspection object ions of a plurality of the ion sensors.

3. The ion sensor chip according to claim 2, wherein the plurality of ion sensors comprises at least three ion sensors.

4. The ion sensor chip according to claim 2, wherein the plurality of ion sensors comprises at least four ion sensors.

5. The ion sensor chip according to claim 1, further comprising:
a history information supply section configured to supply history information indicating whether or not the ion sensor chip is already used to the inspection apparatus.

6. The ion sensor chip according to claim 1, further comprising:
an offset value supply section configured to supply an offset value according to characteristics of the ion sensor to the inspection apparatus.

7. The ion sensor chip according to claim 5, wherein
the history information supply section comprises an IC tag capable of recording and reading out the history information according to a control of the inspection apparatus.

8. The ion sensor chip according to claim 1, wherein the ion sensor is an ion sensitive field effect transistor.

9. An inspection apparatus, comprising:
an ion sensor chip comprising an ion sensor configured to measure an activity of an ion of a category corresponding to a composition of an ion sensitive membrane covering the ion sensor;
a connection section having a plurality of connection terminals; and
an identification information supply section configured to supply identification information corresponding to an inspection object ion of the ion sensor.

10. The inspection apparatus according to claim 9, further comprising:
a plurality of ion sensors each having a different inspection object ion, wherein
the identification information indicates a combination of the inspection object ions of a plurality of the ion sensors.

11. The inspection apparatus according to claim 10, wherein the plurality of ion sensors comprises at least three ion sensors.

12. The inspection apparatus according to claim 10, wherein the plurality of ion sensors comprises at least four ion sensors.

13. The inspection apparatus according to claim 9, further comprising:
a history information supply section configured to supply history information indicating whether or not the ion sensor chip is already used to the inspection apparatus.

14. The inspection apparatus according to claim 9, further comprising:
an offset value supply section configured to supply an offset value according to characteristics of the ion sensor to the inspection apparatus.

15. The inspection apparatus according to claim 13, wherein
the history information supply section comprises an IC tag capable of recording and reading out the history information according to a control of the inspection apparatus.

16. The inspection apparatus according to claim 9, wherein the ion sensor is an ion sensitive field effect transistor.

17. An inspection method, comprising:
generating a voltage corresponding to a concentration in an aqueous liquid of an inspection sample of an inspection object ion of a category corresponding to a composition of an ion sensitive membrane covering an ion sensor;
measures a concentration of the inspection object ion according to the voltage of a terminal of the ion sensor; and
supplying identification information corresponding to the inspection object ion of the ion sensor.

18. The inspection method according to claim 17, further comprising:
using a plurality of ion sensors each having a different inspection object ion; and
supplying identification information indicating a combination of the inspection object ions of the plurality of ion sensors.

19. The inspection method according to claim 17, further comprising:
supplying history information indicating whether or not the ion sensor chip measures the inspection object ion.

20. The inspection method according to claim 17, further comprising:
supplying an offset value according to characteristics of the ion sensor.
